(19) United States
(12) Patent Application Publication
(10) Pub. No.: US 2017/0239841 A1
(43) Pub. Date: Aug. 24, 2017

(54) DAMPED ABRASIVE CUTTER

(71) Applicant: 3M INNOVATIVE PROPERTIES COMPANY, St. Paul, MN (US)

(72) Inventor: JEAN-LUC RIFAUT, Brussels (BE)

(21) Appl. No.: 15/505,643

(22) PCT Filed: Aug. 21, 2015
(86) PCT No.: PCT/US2015/046253

§ 371 Date: Feb. 22, 2017

Related U.S. Application Data
(60) Provisional application No. 62/041,952, filed on Aug. 26, 2014.

(51) Int. Cl. B28D 1/14; B28D 1/04; B24D 7/18; B24B 27/06; B24B 41/00

(52) U.S. Cl. CPC B28D 1/146; B24B 27/0641; B24B 41/007; B24D 7/18; B28D 1/041

(57) ABSTRACT

A damped abrasive cutter having a machine attaching end; an abrasive surface comprising abrasive particles disposed in a binder; a central damping body connecting the machine attaching end to the abrasive surface. The central damping body formed from a synthetic polymer having a Storage Modulus from 1000 MPa to 2500 MPa and a Loss Factor from 0.025 to 0.10.

### BACKGROUND

Brittle materials such as glass, ceramic, glass-ceramic are sensitive to chipping, cracks, or micro-cracks generated during the machining process. These cracks and chips can reduce the lifetime of the produced part or reduce its mechanical properties such as fatigue strength and flexural strength. Thermal properties are also affected and can lead to rejection of the machined part. The maximum acceptable size of the chips or micro-cracks, which drives their propagation behavior between grain boundaries when exiting or though the solid material, is linked with the structure of the material and the balance of forces applied on the part; it can be calculated using the Griffith law and the Weibull distribution. Therefore, it is desirable to reduce chips and micro-cracks to a minimum in quantities and to the maximum acceptable size.

During the machining process of brittle materials like glass, ceramic, glass-ceramic and similar materials, the chips and cracks can be generated due to the pressure applied on the machined part when removing material. For example, when using a combination diamond drill and chamfering bit, the chips and micro-cracks are due to the contact force between the working abrasive diamonds and the brittle material. The contact force is needed to penetrate the abrasive diamonds into the material and the relative movement between the diamonds on the tool and the material forms the hole and the chamfer. If there is vibration between the diamonds and the brittle material during the machining process, each diamond acts as a hammer and can generate chips and micro-cracks at the surface of the material or inside it. That effect can be reduced by adapting machining parameters.

In order to reduce chips and micro-cracks in quantity and size, the usual way is to reduce the diamond grit size or grit quality, lower the bond hardness, or modify the drilling or chamfering machine parameters, such as, by reducing the infeed speed. Those modifications can negatively affect the productivity of the drilling and/or chamfering process by increasing the time needed for the operation and by reducing the useful life of the tool.

A countersink drill bit for glass is disclosed in US patent publication 2002/0004362 having a relatively incompressible plastic body between the drilling head and the mounting shaft for transmitting driving torque. The plastic body is supplied to reduce vibration and chatter. However, improvements in this area are still needed to further improve the productivity of the tool.

### SUMMARY

It has been discovered that improved damping, and thereby a reduction in micro cracks and improved tool life, can be achieved by positioning a central damping body formed from a synthetic polymer between a machine attaching end and an abrasive surface in a damped abrasive cutter. In particular, the synthetic polymer is selected to have specific modulus range and loss factor when tested under dynamic cyclic cycling. The range for these properties that achieves the purpose is a Storage Modulus of the damped central body from 1000 MPa to 2500 MPa and a Loss Factor from 0.025 to 0.10 at 25° C. and 10 Hz.

Hence in one embodiment the invention resides in a damped abrasive cutter comprising: a machine attaching end; an abrasive surface comprising abrasive particles disposed in a binder; a central damping body connecting the machine attaching end to the abrasive surface; and wherein the central damping body comprises a synthetic polymer having a Storage Modulus from 1000 MPa to 2500 MPa and a Loss Factor from 0.025 to 0.10 at 25° C. and 10 Hz.

### BRIEF DESCRIPTION OF THE DRAWINGS

FIGS. 1 and 1A illustrates a damped abrasive countersink drill according to one embodiment.

FIGS. 2 and 2A illustrates a damped abrasive drill according to another embodiment.

FIGS. 3 and 3A illustrates a damped abrasive countersink drill according to another embodiment.

FIGS. 4 and 4A illustrates a damped abrasive countersink drill according to another embodiment.

FIGS. 5 and 5A illustrates a damped abrasive drill according to another embodiment.

### DETAILED DESCRIPTION

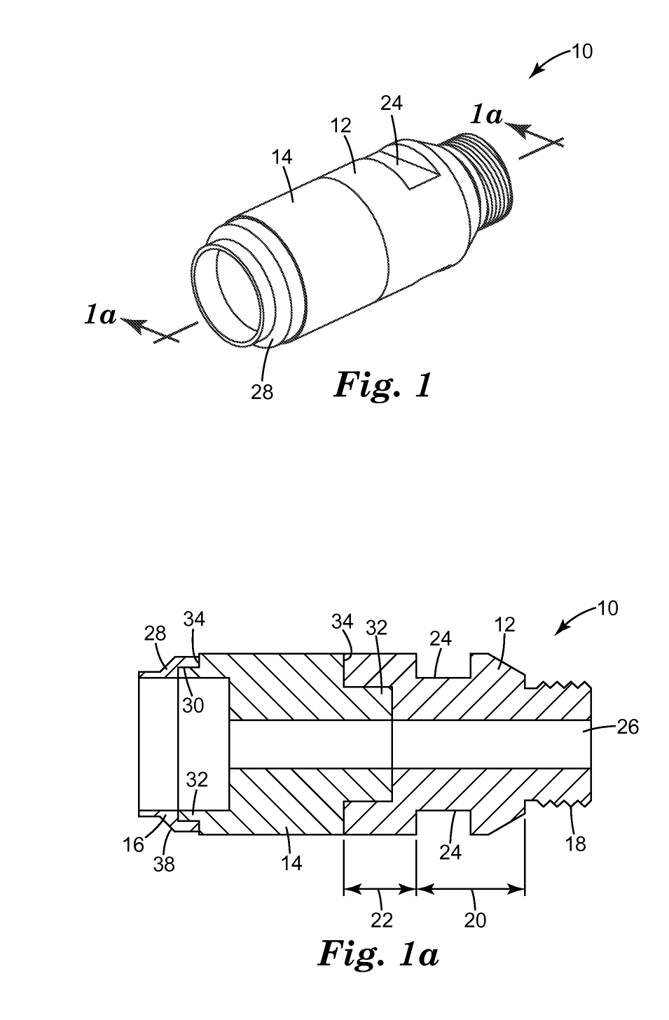

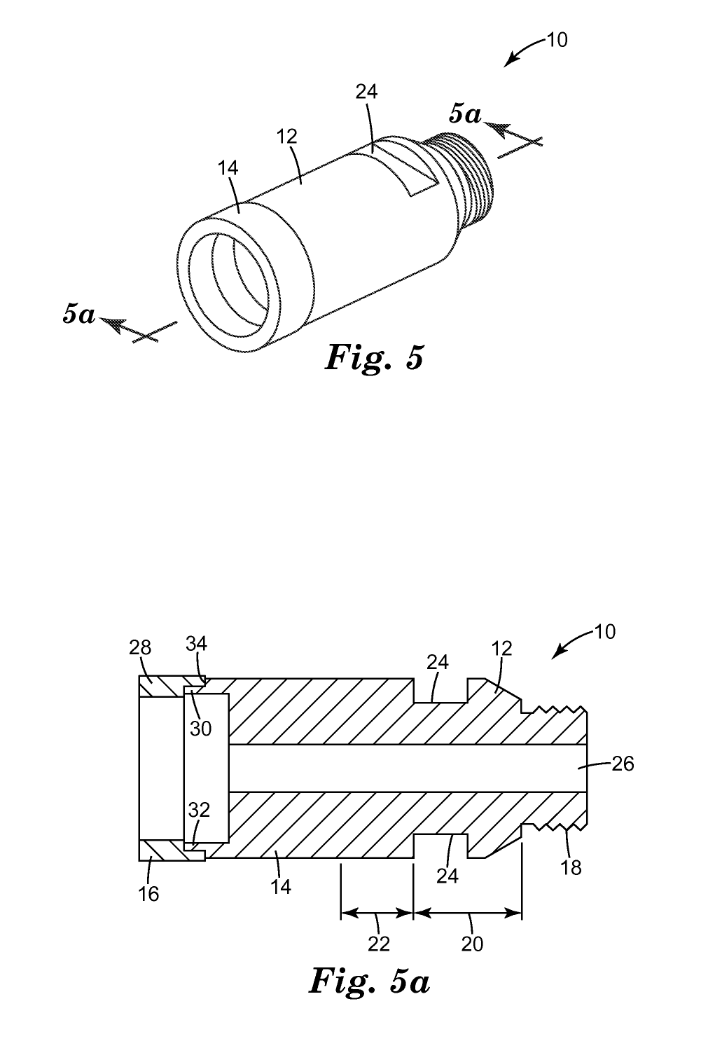

Referring now to FIGS. 1-5 a damped abrasive cutter is shown. The damped abrasive cutter 10 has a machine attaching end 12, a central damping body 14, and an abrasive cutting surface 16. The machine attaching end 12 is configured for transmitting driving torque and linear force from a suitable machine to rotate and translate the damped abrasive cutter relative to the work piece when machining or removing material from the brittle work piece. In some embodiments, as shown in FIG. 5, the machine attaching end 12 and the central damping body 14 can be made from the same material.

The machine attaching end 12 can comprise a round, square, hexagonal, or polygonal shaft, a tapered shaft and collet, a threaded shaft, a round shaft with flats for the jaws of a chuck, or other suitable mechanical structure to transmit the required torque and linear force. Typically the machine attaching end is made from a metal material such as stainless steel for use with cooling or cutting fluids during the machining operation. Other suitable metals, rigid plastics, or the material selected for the central damping body 14 can be utilized for the machine attaching end. In some embodiments, the machine attaching end 12 comprises a threaded first end 18, a middle portion 20, and a cylindrical second end 22 for attaching the central damping body 14. The threaded first end can utilize external or internal threads depending on the configuration of the spindle of the machine used to rotate and translate the damped abrasive cutter. The middle portion 20 can include wrench flats 24 or a hole for use with a drift for installing and removing the threaded first end when replacing the damped abrasive cutter.

In order to cool the damped abrasive cutter during use, an optional longitudinal bore 26 can be provided through the machine attaching end and through the central damping body to supply cooling fluid to the abrasive cutting surface. The size of the bore can be selected based on the flow of coolant required.

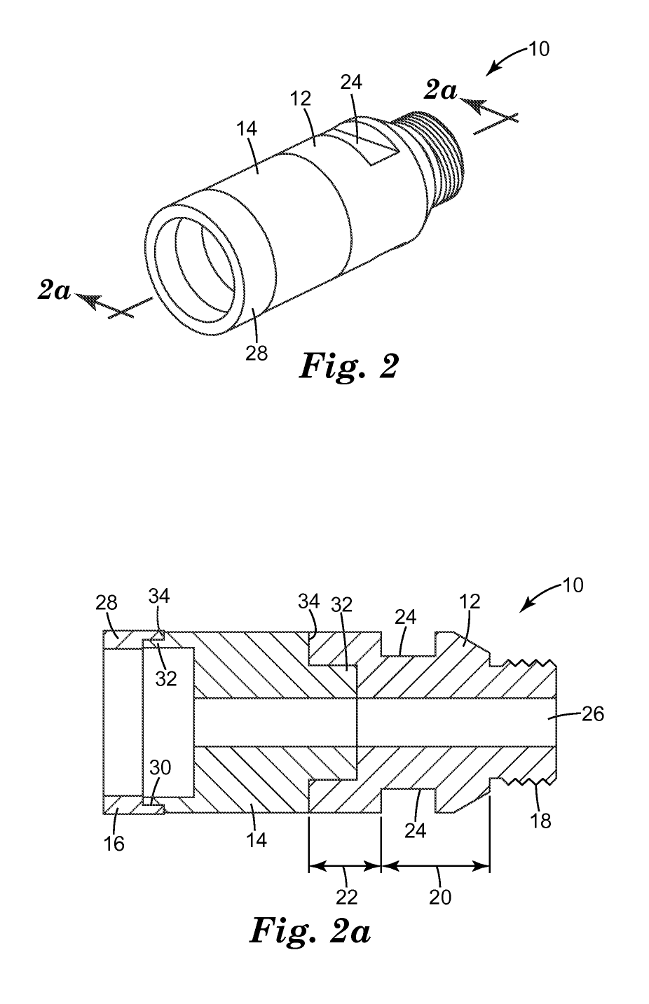

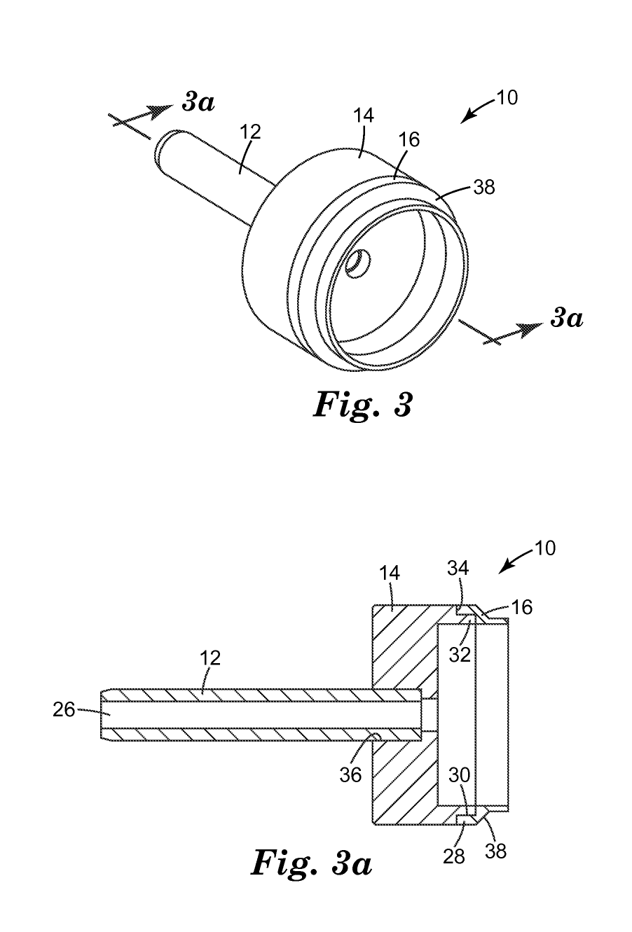

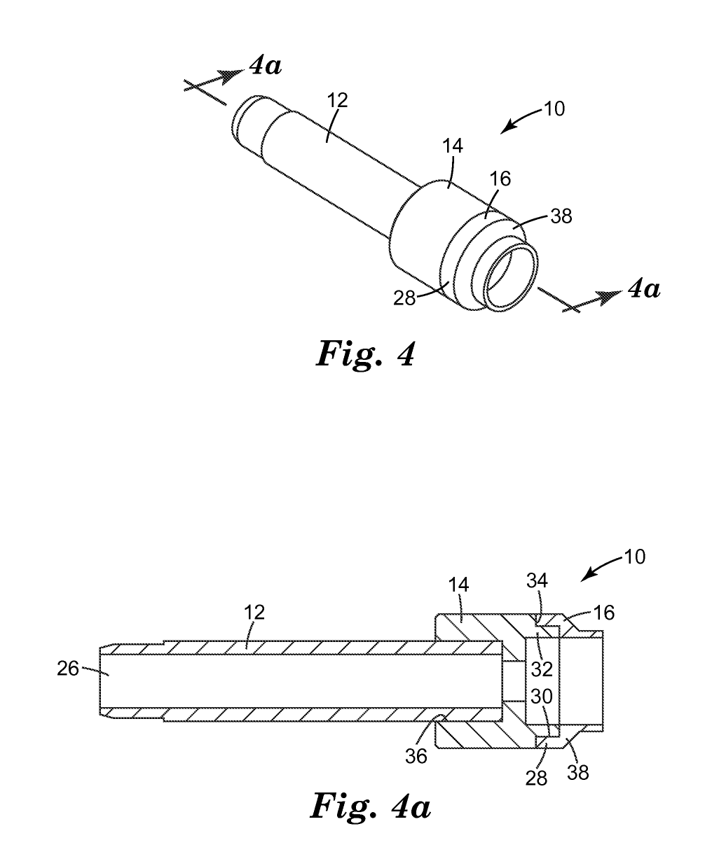

Various mechanical interfaces can be used to connect the abrasive cutting surface 16 and the machine attaching end 12 to the central damping body 14. For example, the abrasive cutting surface 16 can comprise a hollow cylinder 28 with a recessed bore 30 that mates with the central damping body 14 having cylindrical projection 32 extending from a shoulder 34 as shown in FIGS. 1-2. Alternatively, when the machine attaching end 12 comprises a shaft, the shaft can mate with an attaching bore 36 in the central damping body 14 as seen in FIGS. 3-4.

The central damping body 14 is made of a synthetic polymer. The polymer can be a thermoplastic, and selected from polyethylene, polypropylene, polyester, polyamide, polyvinyl, polyetherimide, polydimethylsiloxane or polyetheretherketone for thermoplastic families. For adjusting mechanical, electrical and thermal properties, the synthetic polymer can be reinforced or blended with a filler. Suitable fillers can be fibers or tubes such as carbon fibers or nanotubes, glass fibers, mineral fibers, ceramic fibers, metal fibers or aramid fibers; it can be whiskers such as silicon carbide whiskers or powder such as silicon carbide powder, aluminum oxide powder or metal powder such as aluminum powder, copper powder. Suitable fillers can be a mixture of those components.

A quantity of an anti-wearing agent can be added into the mixture in order to reduce the possible wear of the synthetic polymer body during the drilling and/or chamfering operation when abrasive material is machined. One suitable anti-wearing agent is molybdenum disulfide, graphite or PTFE

In one embodiment, the central damping body was made from polyamide 6 reinforced with glass fibers. In one embodiment, glass fibers are used as a reinforcing material at a level from 1 percent to 50 percent, or from 10 percent to 50 percent, or from 30 percent to 50 percent by weight of the polyamide 6 mixture. A 30 percent glass fiber reinforced polyamide 6 mixture is commercially marketed by Ensinger GmbH under the tradename TECAMID 6 GF30 Black. This material was tested for the Storage Modulus and Loss Factor as described below and found to have a Storage Modulus of 1943 MPa and a Loss Factor of 0.033 at 25° C. and 10 Hz.

Similar mixtures of polyamide 6 with glass fibers are marketed by E.I. du Pont de Nemours—under the tradename DuPont™ Zytel® 73G30T NC010 or DuPont™ Zytel® 73G30T BK261, or by Rhodia SA under the tradename TECHNYL® C216 V30 BLACK Z/4. Other polyamide 6 producers like EMS-Grivory part of the EMS Group under the trade name Grilon® B provide suitable products.

It has been determined that in order to further reduce and/or eliminate chips and micro cracks when using the damped abrasive cutter 10, the Storage Modulus and the Loss factor of the synthetic polymer is important. These properties can be measured using ASTM D4065 Standard Practice for Plastics: Dynamic Mechanical Properties: Determination and Report of Procedures

Dynamic mechanical analysis and sample preparation were performed according to the ASTM D4065-12 standard and the procedures mentioned within. Dynamic mechanical measurements were performed on a DMTA V (Rheometric Scientific) in single cantilever mode in a frequency range from 0.1 to 10 Hz and fixed strain of 0.05% at a temperature of 25° C. to 45° C. Specimens of rectangular shape measuring 20×5×4 mm are used. The temperature calibration was done using a Fluke 724 Temperature Calibrator, which is regularly calibrated by an accredited calibration institute. PVC standards (available through RHEO Service) were measured on the DMTA periodically to check temperature accuracy. The Storage Modulus and Lost Factor values are obtained at 25° C., 35° C., and 45° C. and at 10 Hz.

TABLE 1
Storage Modulus and Loss Factor (10 Hz)

| | | Storage | Loss | |
|---|---|---|---|---|
| | | Modulus | Modulus | Loss |
| | | E′ | E″ | Factor |
| Material | Temp. | Mpa | Mpa | Tan Delta |
| polyamide 6 glass fiber mix | 25° C. | 1943 | 64 | 0.033 |
| (GF30) | 35° C. | 1575 | 128 | 0.081 |
| | 45° C. | 1303 | 106 | 0.082 |
| thermoset glass filled phenolic | 25° C. | 2557 | 60 | 0.024 |
| (x680) (Prior Art) | 35° C. | 3084 | 69 | 0.022 |
| | 45° C. | 3059 | 63 | 0.021 |

As shown in the Examples, a significant reduction in defects during machining of brittle materials and an improved tool life was achieved when the Storage Modulus of the material forming the damped central body is from 1000 MPa to 2500 MPa, or from 1000 MPa to 2000 MPa, or from 1200 MPa to 2000 MPa at 25° C. and 10 Hz. Additionally, for the improvements noted above, the Loss Factor of the material forming the damped central body is from 0.025 to 0.10, or from 0.03 to 0.10, or from 0.03 to 0.09 at 25° C. and 10 Hz. As listed in Table 1, the Storage Modulus at 45° C. and 10 Hz (1303 Mpa) is lower than the Storage Modulus at 25° C. and 10 Hz (1943 Mpa) for the polyamide 6 glass fiber material used for the damped abrasive cutter in one embodiment. The prior art thermoset glass filled phenolic had a Storage Modulus that increased as the temperature of the test was increased whereas the Storage Modulus of the polyamide 6 glass fiber mix decreased as the temperature of the test was increased. The Storage Modulus and Loss Factor are determined in accordance with ASTM D4065 and the test parameters described above.

Another factor in the design of the damped abrasive cutter is the shape and size of the damped central body 14. In general, the length of the central damping body along the longitudinal axis of the abrasive cutter is preferably from 3 mm to about 60 mm although lengths outside of this range may be used as well. If the length becomes too small insufficient damping may occur and if the length becomes too great excessive twisting of the abrasive cutter may occur during use.

The abrasive cutting surface 16 comprises an abrasive particle in a binder. Any suitable abrasive particle may be included in the abrasive cutting surface. Typically, the abrasive particles have a Mohs' hardness of at least 8, or even 9 and 10. Examples of such abrasive particles include aluminum oxide, fused aluminum oxide, ceramic aluminum oxide, white fused aluminum oxide, heat treated aluminum oxide, silica, silicon carbide, green silicon carbide, alumina zirconia, diamond, iron oxide, ceria, cubic boron nitride, garnet, tripoli, alpha alumina sol-gel derived abrasive particles, and combinations thereof.

Typically, the abrasive particles have an average particle size of less than or equal to 1500 micrometers, although average particle sizes outside of this range may also be used. For drilling and chamfering operations, useful abrasive particle sizes typically range from an average particle size in a range of from at least 0.01, 1, 3 or even 5 micrometers up to and including 35, 100, 250, 500, or even as much as 1500 micrometers. In specific embodiments diamond grits between 50 μm and 300 μm are used.

The abrasive cutting surface is generally made by a molding process. During molding, a binder precursor, either liquid organic, powdered inorganic, powdered organic, or a combination of thereof, could be mixed or not with the abrasive particles. In some instances, a liquid medium (either resin or a solvent) is first applied to the abrasive particles to wet their outer surface, and then the wetted particles are mixed with a powdered medium. The abrasive cutting surface according to the present disclosure may be made by compression molding, injection molding, transfer molding, or the like. The molding can be done either by hot or cold pressing or any suitable manner known to those skilled in the art.

The binder typically comprises a glassy inorganic material (e.g., as in the case of vitrified abrasive wheels), metal, or an organic resin (e.g., as in the case of resin-bonded abrasive wheels).

Glassy inorganic binders may be made from a mixture of different metal oxides. Examples of these metal oxide vitreous binders include silica, alumina, calcia, iron oxide, titania, magnesia, sodium oxide, potassium oxide, lithium oxide, manganese oxide, boron oxide, phosphorous oxide, and the like. During manufacture of a vitreous abrasive cutting surface, the vitreous binder, in a powder form, may be mixed with a temporary binder, typically an organic binder. The vitrified binders may also be formed from a frit, for example anywhere from about one to 100 percent frit, but generally 20 to 100 percent frit. Some examples of common materials used in frit binders include feldspar, borax, quartz, soda ash, zinc oxide, whiting, antimony trioxide, titanium dioxide, sodium silicofluoride, flint, cryolite, boric acid, and combinations thereof. These materials are usually mixed together as powders, fired to fuse the mixture and then the fused mixture is cooled. The cooled mixture is crushed and screened to a very fine powder to then be used as a frit binder. The temperature at which these frit bonds are matured is dependent upon its chemistry, but may range from anywhere from about 600.deg. C to about 1800.deg. C.

The binder, which holds the shape of the abrasive cutting surface, is typically included in an amount of from 5 to 50 percent, more typically 10 to 25, and even more typically 12 to 24 percent by weight, based on the total weight of the bonded abrasive wheel.

Examples of metal binders include tin, copper, cobalt, bronze, aluminum, iron, cast iron, manganese, silver, titanium, carbon, chromium, nickel, and combinations thereof in prealloyed forms or not. Metal binders can include fillers such as silicon carbide, aluminum oxide, boron carbide, tungsten, tungsten carbide and combination thereof in prealloyed form or not. During manufacture of a metal abrasive cutting surface, the metal binder, in a powder form, may be mixed with a temporary binder, typically an inorganic binder. The metal binders may also be formed from a mix of pure and prealloyed powder or already pre-mix of metal powders and fillers. These materials are usually mixed together as powders, fired to sinter the mixture and then the sintered mixture is cooled. The temperature at which these metal bonds are matured is dependent upon its chemistry, but may range from anywhere from about 450° C. to about 1100° C.

The binder, which holds the shape of the abrasive cutting surface, is typically included in an amount of from 65 to 98 percent, more typically 75 to 96, and even more typically 88 to 96 percent by weight, based on the total weight of the bonded abrasive wheel.

The binder may comprise a cured organic binder resin, filler, and grinding aids. Phenolic resin is the most commonly used organic binder resin, and may be used in both the powder form and liquid state. Although phenolic resins are widely used, it is within the scope of this disclosure to use other organic binder resins including, for example, epoxy resins, polyimide resins, polyamide-imide resins, polyetherimide resins, polyetherketone resisns, polyetheretherketone resins, polyethersulfone resins, polyester resins, urea-formaldehyde resins, rubbers, shellacs, and acrylic binders. The organic binder may also be modified with other binders to improve or alter the properties of the binder. The amount of organic binder resin can be, for example, from 15 to 100 percent by weight of the total weight of the binder.

Useful phenolic resins include novolac and resole phenolic resins. Novolac phenolic resins are characterized by being acid-catalyzed and having a ratio of formaldehyde to phenol of less than one, typically between 0.5:1 and 0.8:1. Resole phenolic resins are characterized by being alkaline catalyzed and having a ratio of formaldehyde to phenol of greater than or equal to one, typically from 1:1 to 3:1. Novolac and resole phenolic resins may be chemically modified (e.g., by reaction with epoxy compounds), or they may be unmodified. Exemplary acidic catalysts suitable for curing phenolic resins include sulfuric, hydrochloric, phosphoric, oxalic, and p-toluenesulfonic acids. Alkaline catalysts suitable for curing phenolic resins include sodium hydroxide, barium hydroxide, potassium hydroxide, calcium hydroxide, organic amines, or sodium carbonate.

Phenolic resins are well-known and readily available from commercial sources. Examples of commercially available novolac resins include DUREZ 1364, a two-step, powdered phenolic resin (marketed by Durez Corporation of Addison, Tex., under the trade designation VARCUM (e.g., 29302), or HEXION AD5534 RESIN (marketed by Hexion Specialty Chemicals, Inc. of Louisville, Ky.). Examples of commercially available resole phenolic resins useful in practice of the present disclosure include those marketed by Durez Corporation under the trade designation VARCUM (e.g., 29217, 29306, 29318, 29338, 29353); those marketed by Ashland Chemical Co. of Bartow, Florida under the trade designation AEROFENE (e.g., AEROFENE 295); and those marketed by Kangnam Chemical Company Ltd. of Seoul, South Korea under the trade designation “PHENOLITE” (e.g., PHENOLITE TD-2207).

The abrasive cutting surface 16 can be formed into a suitable shape or combination of shapes. One useful shape is a hollow cylinder 28 suitable for machining holes as shown in FIGS. 1-4. The cylinder's outer diameter and wall thickness are selected in order to drill the required size hole into the brittle material. The outer diameter of the hollow cylinder can have sizes from 1 mm up to 200 mm or from 4 mm and 75 mm.

In one embodiment, when the drilling and chamfering operation is done together, the hollow cylinder can comprise a first outer diameter connected to a larger second outer diameter with a frustoconical or chamfered surface 38 as show in FIGS. 1, 3, and 4 for simultaneous machining and chamfering of a chamfered hole into a sheet glass. In some embodiments, the glass is suitable for automotive window use; one such use being for a vehicle's sunroof. The chamfered hole is used in combination with a suitable fastener such as a bolt for installation of the glass into the sunroof mechanism.

In another embodiment, the abrasive cutting surface can comprise a first outer diameter connected to a larger second outer diameter for drilling a blind hole. In any embodiments, the abrasive cutting surface can be a unitary or integral structure or two or more parts fixed or bonded to each other.

In some embodiments, the working end of the hollow cylinder may have one or more longitudinally or radially extending slots. In one embodiment, two pair of opposed longitudinal slots are disposed orthogonally with a slot positioned at 12 o′ clock, 3 o′clock, 6 o′clock, and 9 o′clock positions when looking at the tube's end.

In some embodiments, the abrasive cutting surface is affixed to the central damping body by an adhesive. Suitable industrial adhesives can be used such as an epoxy product sold under the tradename 3M™ Scotch-Weld™ Epoxy Adhesive DP460. In other embodiments, the abrasive cutting surface can be fixed to one or more intermediate materials with sufficient strength to transmit the torque from the damping body to the abrasive cutting surface without slipping.

### EXAMPLES

### Example 1

A diamond metal bonded abrasive cutter as shown in FIG. 1 was tested to drill and chamfer a 15 mm hole in 4.8 mm thick glass. The abrasive cutter had a central damping body made from polyamide 6 reinforced with 30% glass fibers by weight. The polyamide 6 glass fiber mix is commercially marketed by Ensinger GmbH under the tradename TECAMID 6 GF30 Black. This material was tested for the Storage Modulus and Loss Factor as described and found to have a Storage Modulus of 1943 MPa and a Loss Factor of 0.033 at 25° C. and 10 Hz. The abrasive cutter was operated at 3,100 rpm at a feed rate of 65 mm/min, dressing every 50 pieces and cooled with water slightly emulsified with a lubricant additive. The abrasive cutter required a start-up of 5 holes with all start-up pieces made within specifications. Lifetime number of holes was 10,500 with a cycle time of 17 seconds.

### Comparative 1

A diamond metal bonded abrasive cutter as shown in FIG. 1 was tested to drill and chamfer a 15 mm hole in 4.8 mm thick glass. The abrasive cutter had a central damping body made from thermoset glass filled phenolic material from SUMITOMO BAKELITE CO, LTD Group marketed under the trademarks Vincolit® X680. This material was tested for the Storage Modulus and Loss Factor as described and found to have a Storage Modulus of 2557 MPa and a Loss Factor of 0.024 at 25° C. and 10 Hz. The abrasive cutter was operated at 3,100 rpm at a feed rate of 65 mm/min, dressing every 50 pieces and cooled with water slightly emulsified with a lubricant additive. The abrasive cutter required a start-up of 5 holes with all glass pieces made within specifications. Lifetime number of holes was 7,000 with a cycle time of 17 seconds.

### Comparative 2

A diamond metal bonded abrasive cutter without a central damping body identified as a chamfering drill from Gem Europe 3 was tested to drill and chamfer a 15 mm hole in 4.8 mm thick glass. The abrasive cutter was operated at 3,100 rpm at a feed rate of 65 mm/min, dressing every 50 pieces and cooled with water slightly emulsified with a lubricant. The abrasive cutter required a start-up of 5 holes with all pieces made within specifications. Lifetime number of holes was 6,000 with a cycle time of 17 seconds.

### Embodiments of the Invention

1. A damped abrasive cutter comprising:
   a machine attaching end;
   an abrasive surface comprising abrasive particles disposed in a binder;
   a central damping body connecting the machine attaching end to the abrasive surface; and
   wherein the central damping body comprises a synthetic polymer having a Storage Modulus from 1000 MPa to 2500 MPa and a Loss factor from 0.025 to 0.10 at 25° C. and 10 Hz.
2. The damped abrasive cutter of embodiment 1 wherein the central damping body comprises polyamide 6.
3. The damped abrasive cutter of embodiment 1 wherein the central damping body comprises polyamide 6 and glass fibers.
4. The damped abrasive cutter of embodiment 3 wherein the glass fibers comprise from 1 to 50 percent by weight of the central damping body.
5. The damped abrasive cutter of embodiment 3 wherein the glass fibers comprise 30 percent by weight of the central damping body.
6. The damped abrasive cutter of embodiment 1 wherein the machine attaching end and the central damping body comprise a synthetic polymer having a Storage Modulus from 1000 MPa to 2500 MPa and a Loss factor from 0.025 to 0.10 at 25° C. and 10 Hz.
7. The damped abrasive cutter of embodiments, 1, 2, 3, 4, 5, and 6 wherein the Storage Modulus obtained at 25° C. and 10 Hz is greater than the Storage Modulus obtained at 45° C. and 10 Hz for the central damping body.

What is claimed is:

1. A damped abrasive cutter comprising:
a machine attaching end;
an abrasive surface comprising abrasive particles disposed in a binder;
a central damping body connecting the machine attaching end to the abrasive surface; and
wherein the central damping body comprises a synthetic polymer having a Storage Modulus from 1000 MPa to 2500 MPa and a Loss factor from 0.025 to 0.10 at 25° C. and 10 Hz.

2. The damped abrasive cutter of claim 1 wherein the central damping body comprises polyamide 6.

3. The damped abrasive cutter of claim 1 wherein the central damping body comprises polyamide 6 and glass fibers.

4. The damped abrasive cutter of claim 3 wherein the glass fibers comprise from 1 to 50 percent by weight of the central damping body.

5. The damped abrasive cutter of claim 3 wherein the glass fibers comprise 30 percent by weight of the central damping body.

6. The damped abrasive cutter of claim 1 wherein the machine attaching end and the central damping body comprise a synthetic polymer having a Storage Modulus from 1000 MPa to 2500 MPa and a Loss factor from 0.025 to 0.10 at 25° C. and 10 Hz.

7. The damped abrasive cutter of claim 1 wherein the Storage Modulus obtained at 25° C. and 10 Hz is greater than the Storage Modulus obtained at 45° C. and 10 Hz for the central damping body.
